(19) United States
(12) Patent Application Publication
(10) Pub. No.: US 2009/0044869 A1
(43) Pub. Date: Feb. 19, 2009

(54) Irrigation valve box

(76) Inventors: Wayne Brown, Fort Worth, TX (US); Morris A. Brown, Fort Worth, TX (US)

Correspondence Address: W. THOMAS TIMMONS, 1320 PRUDENTIAL DRIVE, SUITE 208, DALLAS, TX, 75235-4117, US

(21) Appl. No.: 12/070,617

(22) Filed: Feb. 19, 2008

Related U.S. Application Data
(60) Provisional application No. 60/902,927, filed on Feb. 22, 2007.

(51) Int. Cl. F16L 3/00

(52) U.S. Cl. 137/363; 209/546

(57) ABSTRACT

An irrigation valve box includes a body for shielding the valve, which forms an opening at the top, and a removable lid for fitting into the opening formed by the body. Access to the valve is normally gained by removing the lid. Metal is associated with the valve box for the purpose of being detected by a metal detector. In one arrangement the metal forms a plate which fits into the removable lid. In an arrangement especially suited for a larger or commercial valve box, the metal forms a metal ring which fits into the removable lid. In yet another arrangement, the lid comprises molded plastic or molded rubber and the metal is molded into the lid. In one such an arrangement, the metal forms a wire mesh. A method for detecting an irrigation valve box which is hidden from view by soil or grass, includes the combination steps of associating metal with the valve box at an earlier time when the location of the valve box was known, so that the metal is detectable by a metal detector, and using a metal detector to locate the metal, and thereby to locate the valve box. One arrangement of the method includes the steps of forming the metal into a plate and fitting the metal plate into the removable lid. Another arrangement of the method includes the steps of forming the metal into a metal ring and fitting the metal ring into the removable lid. Yet another arrangement of the method includes the step of forming the metal into the removable lid, such as forming the metal into a mesh molded into the removable lid.

### CROSS-REFERENCE TO RELATED APPLICATIONS

None

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to irrigation systems for homes, golf courses and other commercial uses, and in particular to boxes which house valves for turning water on and off. The present invention also includes a method for making such valve boxes that have been silted over easy to detect and a method for detecting such hidden valve boxes.

2. Description of Related Art

At one time, companies which installed irrigation systems gave the owner of the property a map of the sprinkler system, showing the lines and the location of the valve boxes. The practice of providing maps fell into disuse as the market for installing such systems became more price competitive.

A wire and valve detector, known as a 521, sends a signal down the wires and through the valves which can be detected with a specially designed “wand.” Such transmitter/detectors are expensive and require special training to use properly. If the location is in an electrical hot spot, then detection becomes difficult or impossible. If wires are broken or faulty, then the transmitter does not work. It is also necessary to have access to the central electronics of the irrigation system, which may mean that a homeowner or business owner must be present. The use of such a transmitter/detection system is also time consuming.

### BRIEF SUMMARY OF THE INVENTION

An irrigation valve box according to the present invention includes a body for shielding the valve. The body forms an opening at the top, and a removable lid is included for fitting into the opening formed by the body. Access to the valve is normally gained by removing the lid. Metal is associated with the valve box for the purpose of being detected by a metal detector.

In one arrangement the metal forms a plate which fits into the removable lid. In an arrangement especially suited for a larger or commercial valve box, the metal forms a metal ring which fits into the removable lid. In yet another arrangement, the lid comprises molded plastic or molded rubber and the metal is molded into the lid. In one such an arrangement, the metal forms a wire mesh.

A method according to the present invention for detecting an irrigation valve box which is hidden from view by soil or grass, includes the combination steps of associating metal with the valve box at an earlier time when the location of the valve box was known, so that the metal is detectable by a metal detector, and using a metal detector to locate the metal, and thereby to locate the valve box. One arrangement of the method includes the steps of forming the metal into a plate and fitting the metal plate into the removable lid. Another arrangement of the method includes the steps of forming the metal into a metal ring and fitting the metal ring into the removable lid. Yet another arrangement of the method includes the step of forming the metal into the removable lid. Especially suited to this method is forming the metal into a mesh molded into the removable lid.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a pictorial representation of a person using an irrigation valve box and method according to the present invention;

FIG. 2 is vertical cross section of a valve box according to the present invention;

FIG. 3 is a vertical cross section of another embodiment of a valve box according to the present invention; and

FIG. 4 is a vertical cross section of yet one more embodiment of the present invention.

### DETAILED DESCRIPTION OF THE INVENTION

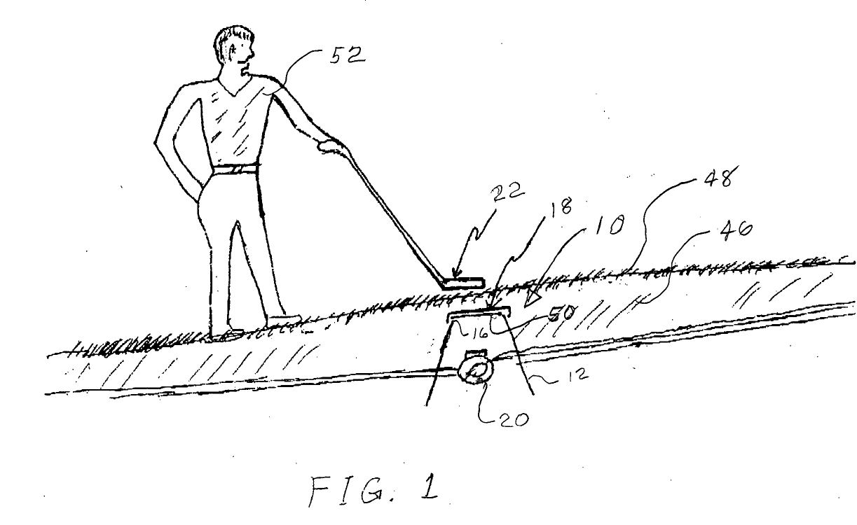

Referring now to the drawing, and in particular to FIG. 1, an irrigation valve box according to the present invention is referred to generally by reference numeral 10. Valve box 10 includes the combination of a body 12 for shielding the valve 14. Body 12 forms an opening 16 at the top, and a removable lid 18 fits into the opening formed by the body. Access to a valve 20 is normally gained by removing the lid, and metal associated with the valve box for the purpose of being detected by a metal detector 22.

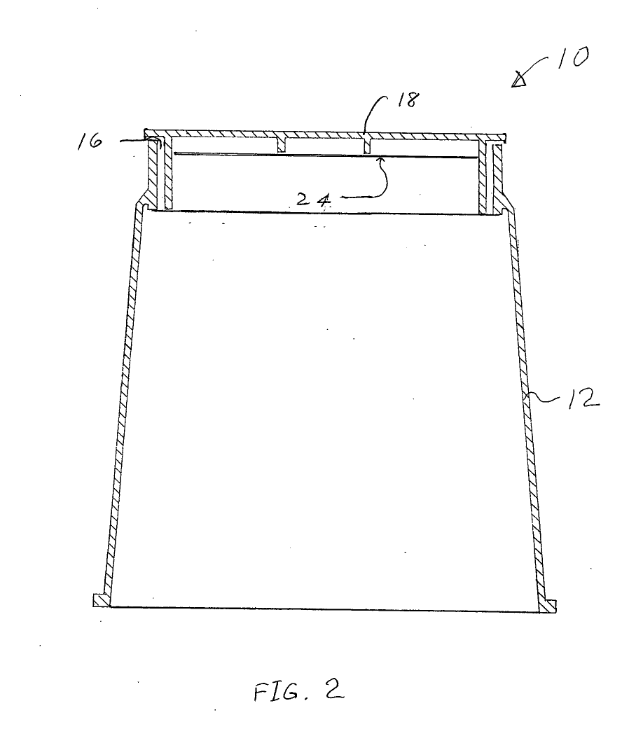

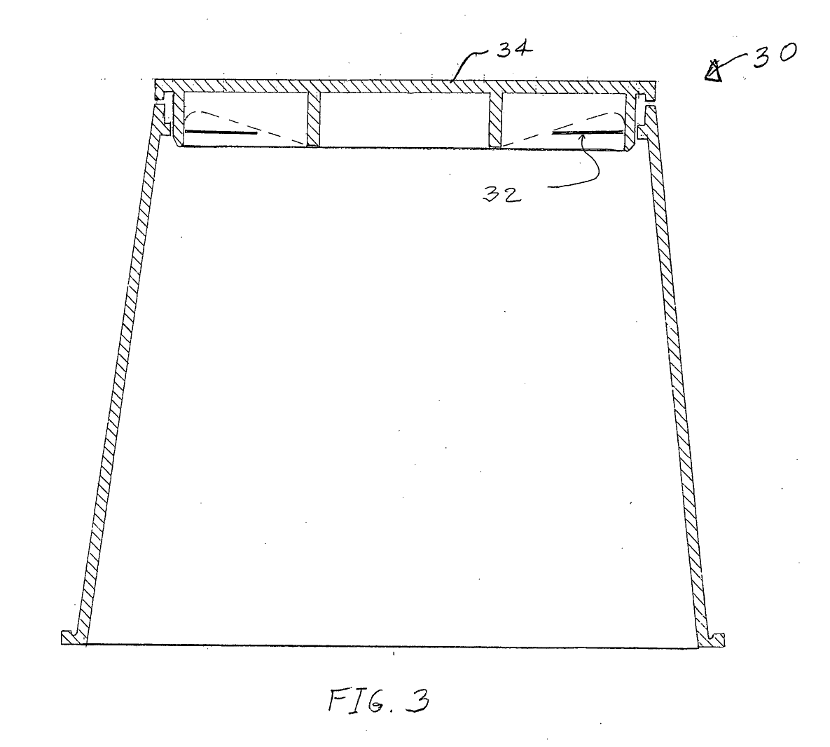

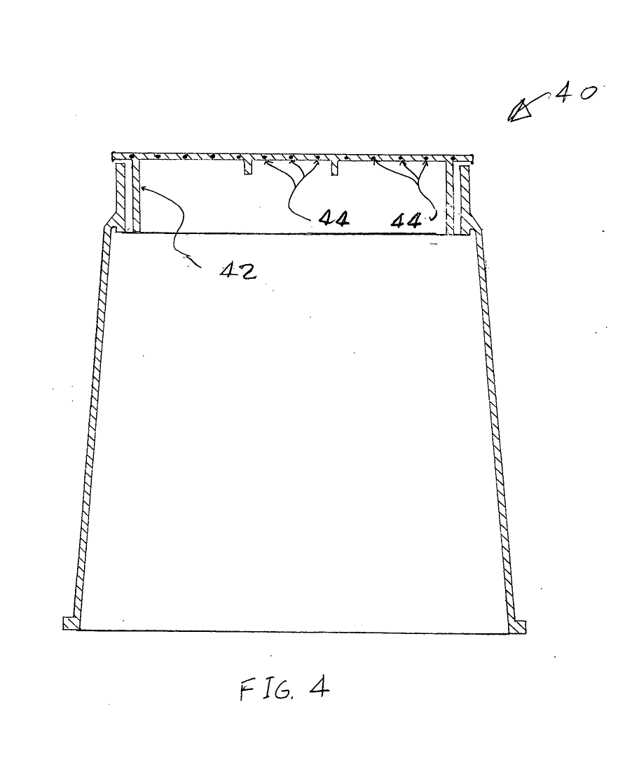

Referring also to FIG. 2, in one arrangement of a standard six inch irrigation valve box 10 the metal forms a plate 24 which fits into removable lid 18. Referring now to FIG. 3, a larger or commercial valve box, typically a standard ten inch irrigation valve box, is referred to generally by reference numeral 30. The metal forms a metal ring 32 which fits into a removable lid 34. In such an arrangement, the cut-out taken from the center of the metal to make the ring is made to fit as plate 24 of the smaller valve box shown in FIG. 2. Referring now to FIG. 4, another embodiment of a valve box according to the present invention is referred to generally by reference numeral 40. Removable lid 42 comprises molded plastic or molded rubber and the metal is molded into the lid. In one such an arrangement, the metal forms a wire mesh 44.

Referring again to FIG. 1, a method according to the present invention for detecting an irrigation valve box which is hidden from view by soil 46 or grass 48, includes the combination steps of associating metal 50 with valve box 10 at an earlier time when the location of the valve box was known, so that the metal is detectable by a metal detector. A user 52 uses metal detector 22 to locate metal 50, and thereby to locate valve box 10. One arrangement of the method includes the steps of forming the metal into a plate and fitting the metal plate into the removable lid as shown in FIG. 2. Another arrangement of the method includes the steps of forming the metal into a metal ring and fitting the metal ring into the removable lid as shown in FIG. 3. Yet another arrangement of the method includes the step of forming the metal into the removable lid as shown in FIG. 4. Especially suited to this method is forming the metal into a mesh molded into the removable lid.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. An irrigation valve box, comprising in combination:
a body for shielding the valve, wherein the body forms an opening at the top;
a removable lid for fitting into the opening formed by the body, wherein access to the valve is normally gained by removing the lid; and
metal associated with the valve box for the purpose of being detected by a metal detector.

2. An irrigation valve box according to claim 1, wherein the metal forms a plate which fits into the removable lid.

3. An irrigation valve box according to claim 1, wherein the metal forms a metal ring which fits into the removable lid.

4. An irrigation valve box according to claim 1, wherein the lid comprises molded plastic and the metal is molded into the lid.

5. An irrigation valve box according to claim 4, wherein the metal forms a wire mesh.

6. An irrigation valve box according to claim 1, wherein the lid comprises molded rubber and the metal is molded into the lid.

7. An irrigation valve box according to claim 6, wherein the metal forms a wire mesh.

8. A lid for an irrigation valve box having a body which forms an opening at the top, comprising in combination:
a removable lid for fitting into the opening formed by the body, wherein access to the valve is normally gained by removing the lid; and
metal associated with the lid for the purpose of being detected by a metal detector.

9. An irrigation valve box according to claim 8, wherein the metal forms a plate which fits into the removable lid.

10. An irrigation valve box according to claim 8, wherein the metal forms a metal ring which fits into the removable lid.

11. An irrigation valve box according to claim 8, wherein the lid comprises molded plastic and the metal is molded into the lid.

12. An irrigation valve box according to claim 11, wherein the metal forms a wire mesh.

13. An irrigation valve box according to claim 8, wherein the lid comprises molded rubber and the metal is molded into the lid.

14. An irrigation valve box according to claim 13, wherein the metal forms a wire mesh.

15. A method for detecting an irrigation valve box which is hidden from view by soil or grass, comprising in combination the steps of:
associating metal with the valve box at an earlier time when the location of the valve box was known, wherein the metal is detectable by a metal detector; and
using a metal detector to locate the metal, and thereby to locate the valve box.

16. A method according to claim 15, further comprising the steps of forming the metal into a plate and fitting the metal plate into the removable lid.

17. A method according to claim 15, further comprising the steps of forming the metal into a metal ring and fitting the metal ring into the removable lid.

18. A method according to claim 15, further comprising the step of forming the metal into the removable lid.

19. A method according to claim 15, further comprising the step of forming the metal into a mesh molded into the removable lid.
